(19) United States
(12) Patent Application Publication
(10) Pub. No.: US 2010/0207805 A1
(43) Pub. Date: Aug. 19, 2010

(54) OBTAINING AN INDICATION OF A NUMBER OF MOVING OBJECTS PASSING SPEED DETECTION APPARATUS

(75) Inventor: Simon Charles HAWORTH, Cheltenham Gloucestershire (GB)

Correspondence Address: YOUNG & THOMPSON, 209 Madison Street, Suite 500, Alexandria, VA, 22314, US

(73) Assignee: AGD SYSTEMS LIMITED, Cheltenham Gloucestershire (GB)

(21) Appl. No.: 12/689,532

(22) Filed: Jan. 19, 2010

Related U.S. Application Data
(60) Provisional application No. 61/153,744, filed on Feb. 19, 2009.

(51) Int. Cl. G01S 13/58; G01P 3/00; G06F 15/00

(52) U.S. Cl. 342/104; 702/142

(57) ABSTRACT

Apparatus and method for obtaining an indication of a number of moving objects passing a speed detection apparatus. Data representing a record of speed events over a series of time frames is obtained (208, 210), each time frame including a record of zero or more distinct speeds detected during that time frame. The speed events data is analysed (604) to identify approach characteristics associated with one moving object approaching the detection apparatus. The speed events data is also analysed (606) to identify passing characteristics associated with the moving object passing the detection apparatus. A moving object count is updated (608) after detecting the approaching characteristic and the passing characteristic in sequence.

The present application claims priority from U.S. Provisional Ser. No. 61/153,744 filed on Feb. 19, 2009.

### FIELD OF THE INVENTION

The present invention relates to detecting and counting moving targets.

### BACKGROUND TO THE INVENTION

The use of radar devices for detecting the speed of moving targets/objects, e.g. on-road vehicles, is well-known. Such devices can be mounted in hand-held units or in roadside warning signs that flash up a warning when a car is travelling over the designated speed limit, for example. The majority of existing products use a narrow antenna beam pattern or place the radar at an angle across the road (or implement both of these techniques) to try to ensure that there can only be a single vehicle in the radar beam at any instant in order to maximise the accuracy of their integral counting facility. Generally, this has meant that manufacturers have either had to consider including two radars in each such piece of equipment: one for triggering the sign when the speed limit is exceeded and another for use in connection with the count function. Alternatively, the control of the device may be altered to concentrate on count or detection functions, leading to compromised performance.

### SUMMARY OF THE INVENTION

Embodiments of the present invention are intended to obtain a reasonable indication of a number of moving vehicles that has passed a speed detection device using one radar signal only.

According to a first aspect of the present invention there is provided a method of obtaining an indication of a number of moving objects passing a speed detection apparatus, the method including:

obtaining data representing a record of speed events over a series of time frames, each said time frame in the speed events record including a record of zero or more distinct speeds detected during that time frame;

analysing the speed events data to identify approach characteristics associated with one moving object approaching the detection apparatus;

analysing the speed events data to identify passing characteristics associated with the moving object passing the detection apparatus, and

updating (typically incrementing) a moving object count after detecting a said approaching characteristic and a said passing characteristic in sequence.

The method may include (for each time frame in the speed events data):

adding data representing a number of distinct speed event or events associated with a said time frame to a potential target set if the speed event or events of that time frame meets a first criteria;

adding data representing a number of distinct speed event or events associated with a said time frame to a validated target set if the speed event or events of that time frame meets a second criteria, and

creating a Speed Event History set, each member of the Speed Event History set comprising a difference between the potential target set number for a said time frame and the validated target set number for the time frame.

The step of analysing the speed events data to identify approach characteristics associated with one said moving object approaching the detection apparatus may include searching the Speed Event History set over a series of time frames for a series of numbers that correspond to approach characteristics. The approach characteristics may include a series of incrementing numbers.

The step of analysing the speed events data to identify approach characteristics associated with one said moving object passing the detection apparatus may include searching the Speed Event History set over a series of time frames for a series of numbers that correspond to passing characteristics. The passing characteristics may include a series of decrementing numbers.

The method may further include a step of disregarding a certain number of speed events following the incrementing of the moving object count.

The method may involve use of a state engine including states of: Waiting for vehicles; Approaching vehicle detected; Passing vehicle detected, and Gapping following Passing vehicle.

The speed events data may be generated by performing a complex FFT transformation on data obtained from a Doppler radar signal. The radar signal may be generated by a hand-held speed detection apparatus. The radar signal may comprise a continuous wave Doppler radar signal.

The method may further include performing a further function associated with a speed event that meets a specific criteria, such as switching on a warning signal when the speed event indicates that a certain speed threshold has been broken by the moving object.

According to a further aspect of the present invention there is provided a computer program product comprising a computer readable medium, having thereon computer program code means, when the program code is loaded, to make the computer execute a method of obtaining an indication of a number of moving objects passing a speed detection apparatus substantially as described herein.

According another aspect of the present invention there is provided a apparatus adapted to obtaining an indication of a number of passing moving objects, the apparatus including:
a transmitter for transmitting a radar signal;
a receiver for receiving a radar signal;
a device configured to:
   convert received radar signals into data representing a record of speed events over a series of time frames, each said time frame in the speed events record including a record of zero or more distinct speeds detected during that time frame;
   analyse the speed events data to identify approach characteristics associated with one moving object approaching the detection apparatus;
   analyse the speed events data to identify passing characteristics associated with the moving object passing the detection apparatus, and
   update a moving object count after detecting a said approaching characteristic and a said passing characteristic in sequence.

The apparatus may comprise a vehicle speed detection apparatus.

The processing device may implement a state engine including states of: Waiting for vehicles; Approaching vehicle detected; Passing vehicle detected, and Gapping following detection of a Passing vehicle.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWINGS

The invention may be performed in various ways, and, by way of example only, embodiments thereof will now be described, reference being made to the accompanying drawings in which:

FIG. 1 is a block diagram illustrating components of example radar apparatus including a processor;

FIG. 2 is a functional overview of steps performed by the processor, including potential target search, target validation and target count steps;

FIGS. 3A and 3B illustrate radar device readings as vehicles approach and pass the device;

FIG. 4 is a flowchart detailing the potential target search step of FIG. 2;

FIG. 5 is a flowchart detailing the target validation step of FIG. 2;

FIG. 6 is a flowchart detailing the target count step of FIG. 2;

FIGS. 7 and 8 are flowcharts detailing another embodiment of the process.

### DETAILED DESCRIPTION OF THE DRAWINGS

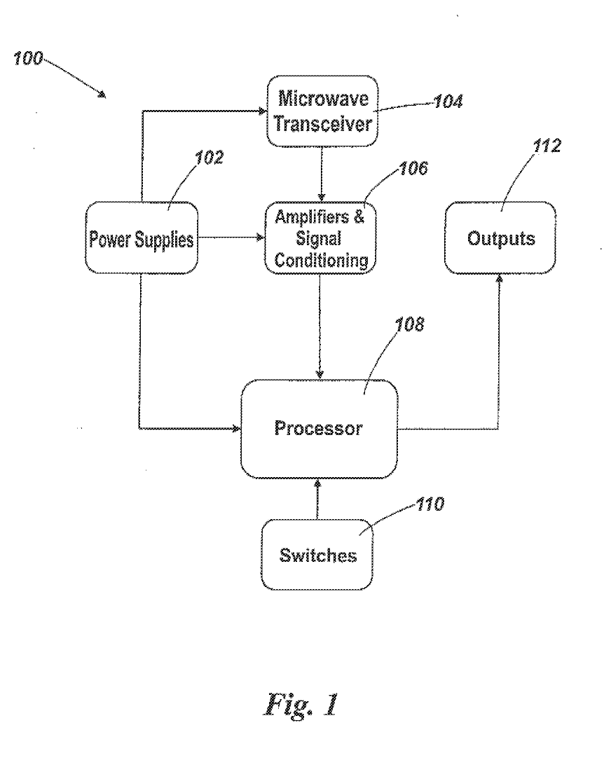

FIG. 1 is a block diagram of an example device 100 that includes power supplies 102 that are connected to a microwave transceiver 104, amplifiers and signal conditioning devices 106 and a processor 108. It will be appreciated that the device illustrated is exemplary only and some of the components can be omitted or replaced by alternatives. The device 100 includes internal memories and a variety of onboard peripherals, including built-in analogue to digital converters. The analogue-to-digital converters are capable of offering simultaneous sampling of a number of channels, which is important for digitisation of the I and Q signals from the transceiver module 104. Connected to the processor 108 are switches 110 for configuring and operating the device, as well one or more output 112. It will be appreciated that the inputs and outputs of the device can vary. In one practical example, the outputs can be connected to an integral display device or to a remote computer for storage and display of the information recorded by the device 100.

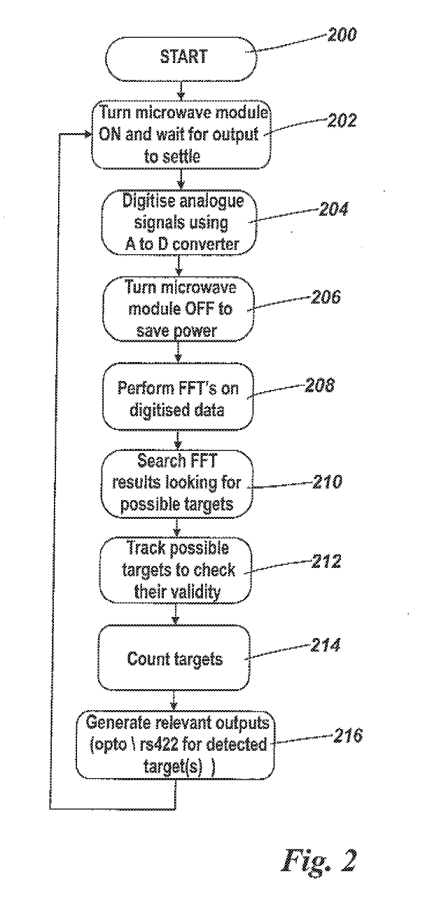

Turning to FIG. 2, an overview of the functions performed by the device 100 is shown. When the device is initiated at step 200 the microwave module is switched on and there is a wait for its output to settle at step 202. After conventional use of the microwave module in terms of transmitting and receiving a Doppler signal, the analogue signals received by the device are converted to digital form at step 204. Optional step 206 involves switching off the microwave module in order to save power. At step 208 Fast Fourier transforms are performed on the digitised data. The type of FFT performed may be a complex FFT.

At step 210 the FFT results are searched in order to identify potential targets, i.e. moving vehicles. In the example described herein the FFT data effectively records different speed events, i.e. a record of how many different speed(s) were detected during each time frame in a series. Therefore, two or more vehicles travelling at the same speed may only result in a single speed event being recorded. At step 212 an operation is performed in order to check the validity of the possible targets identified at the previous step. In brief, step 212 involves reviewing a “history” of speed event records to try to assess whether speed events relate to one or more vehicles approaching/passing the device 100. At step 214 the number of validated targets is counted so that a reasonably accurate indication of the number of different targets that have passed the device 100 is obtained. At step 216 outputs relating to the measurements taken by the device are output in any suitable format and control can pass back to step 202 to repeat the process.

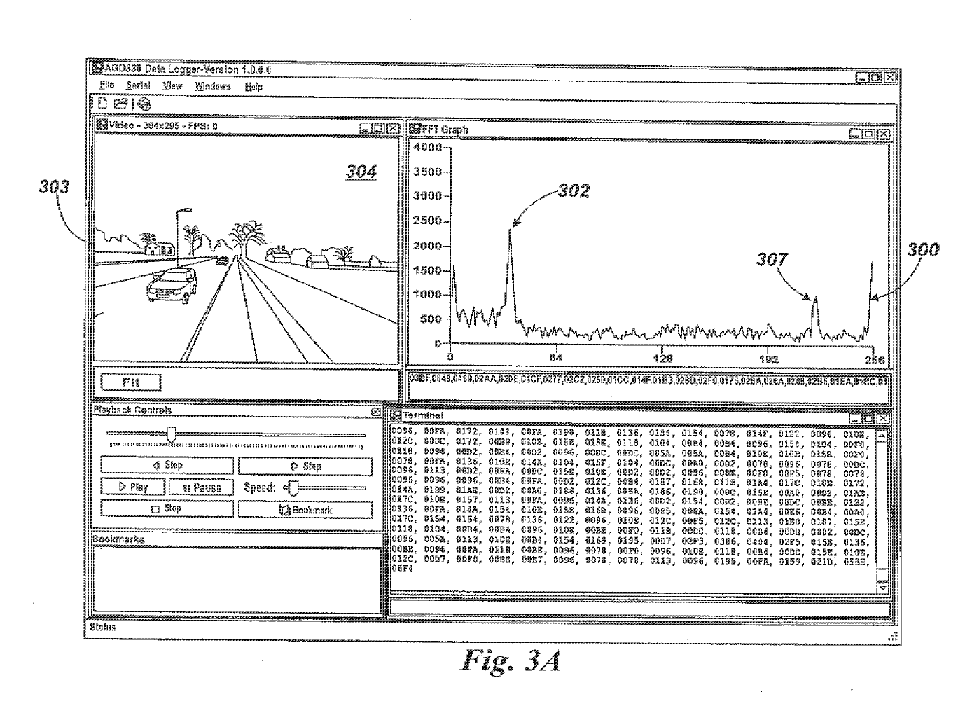

The present inventor has discovered that as a result of the beam pattern of the antenna being used and the method of processing (using an FFT rather than the simple zero crossing approach) it is possible to detect not only a number of vehicles moving at different speeds, but also to count the vehicles as they pass the radar device. FIGS. 3A and 3B illustrate schematically an effect that is used by an embodiment of the device in order to perform the counting function. In FIG. 3A, the power signal 300 includes a peak 302 that corresponds to a car 303 (visible in the foreground of the corresponding image display 304) approaching the radar device. The FFT output shows a single peak 302 at around 30 mph (note that the second car in the background of the image must be travelling at the same speed as the first car because there is only one approaching peak), and a peak 307 in the receding direction corresponds to a vehicle in the distance and is not an image from either of the approaching vehicles visible in the image display 304.

FIG. 3B shows the car 303 passing the radar device in the image display. The peak marked 302 in the graph of FIG. 3A has become distorted and now comprises a number of peaks 302′. It is believed that these further peaks are caused by multiple reflections of radar signals from the wheels of the passing vehicle and are very short-lived effects, normally only lasting a few frames or so. Each of these peaks could register when a power level/speed threshold is applied to an analysis of the data, but, in fact, the multiple peaks may stem from the wheels of only a single vehicle passing the radar device. The present inventor has appreciated that detecting the occurrence of this type of distorted peak effect after the occurrence of the type of peak shown in FIG. 3A can indicate that a vehicle has approached and then passed the radar device. Incrementing a counter each this effect is detected results in a reasonably accurate count of the number of vehicles that have passed the device, although it will be noted that two or more vehicles passing at exactly the same speed would not necessarily trigger the effect in the same way and so may lead to an inaccurate count, but the applications envisaged for the embodiments of the present invention do not require 100% accuracy and so the output produced by the radar device will suffice for such applications, e.g. council surveys, etc.

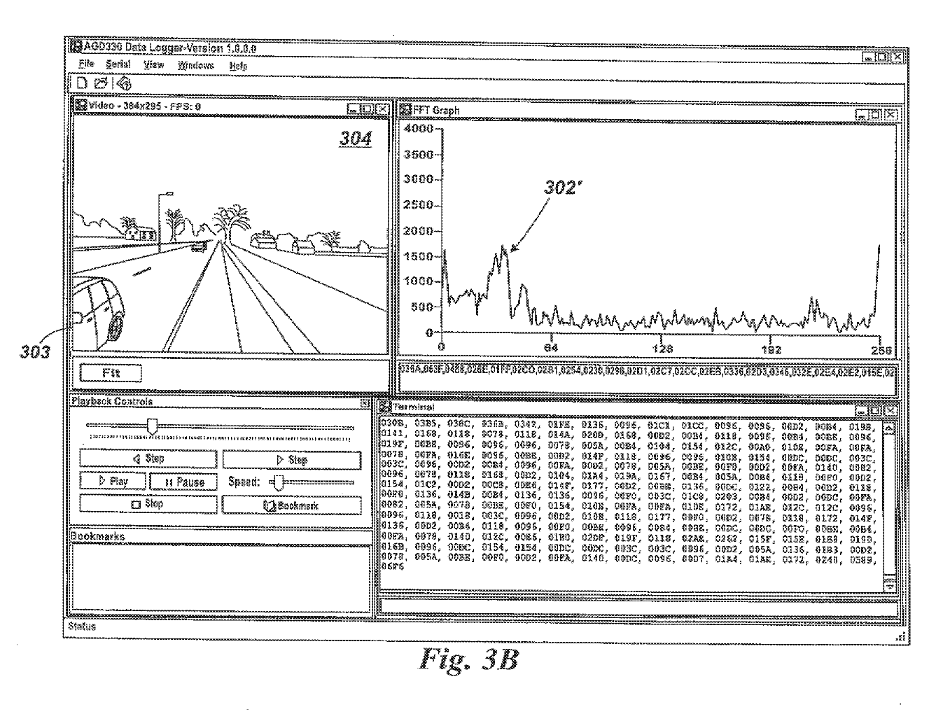

FIG. 4 illustrates schematically steps performed during the step 210 of FIG. 2, where the FFT results are searched for potential targets. At step 402 the first/next time frame to be analysed is selected. At step 404 a check is performed to see whether the power level/speed of the speed event(s) of that time frame is greater than a predetermined threshold. It will be appreciated that the threshold can be selected in accordance with various factors, e.g. experimental data, the minimum speed that is to trigger the device, and so on. If the answer to that question is positive then at step 406 the speed and power level(s) of the speed events of that time frame is/are recorded in an entry in a “Potential Target” array. It will be appreciated that an array is only one example of a suitable data structure and alternative data structures/sets can be used. The steps of FIG. 4 will be repeated for a desired number of time frames.

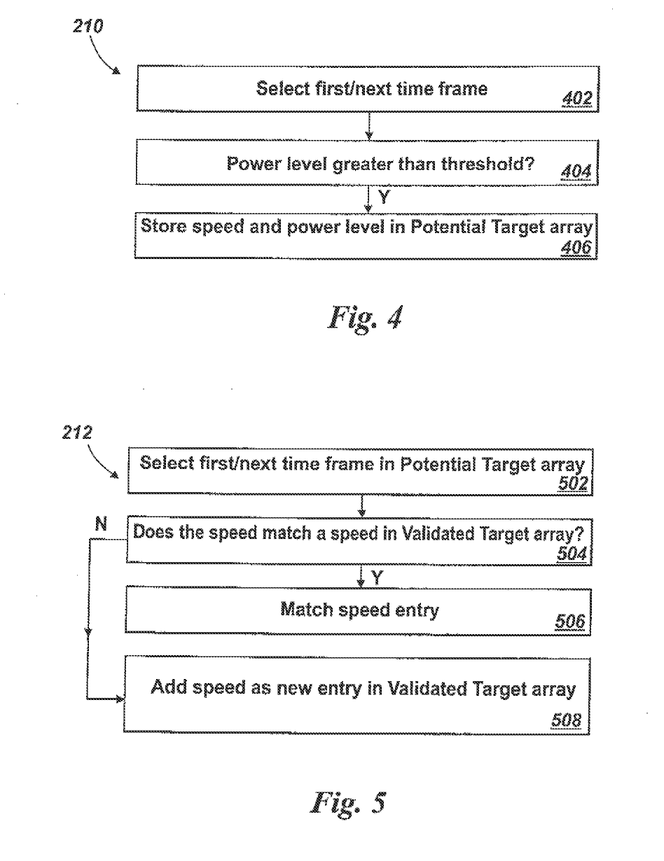

FIG. 5 details steps performed during the target validation procedure 212. At step 502 the first/next time frame in the “Potential Target” array is selected. At step 504 a check is performed to see whether the speed of the speed event(s) of the selected array member matches the speed(s) of the corresponding time frame in a “Validated Target” array. When the algorithm is first executed the “Validated Target” array will be empty. A best match algorithm (or the like) can be used for the check. If the speed event(s) do/does not match one recorded in the “Validated Target” array then at step 508 the speed event selected at step 502 is added as a new entry in the “Validated Target” array.

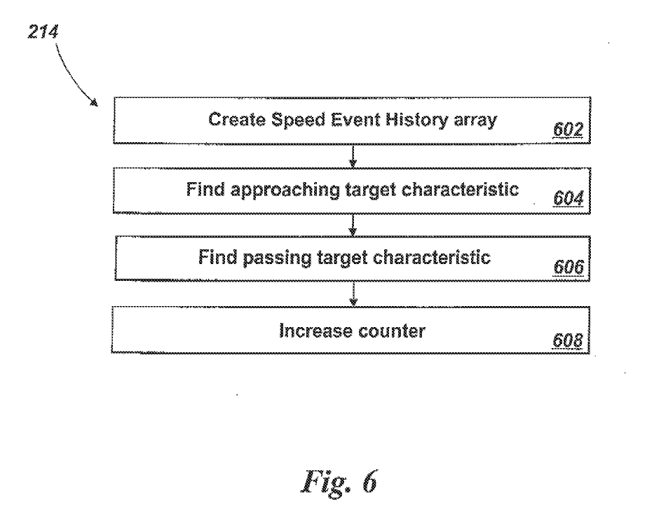

FIG. 6 details steps performed during the count target process 214. At step 602 a “Speed Event History” array is created. The entries in this array comprise the result of subtracting the number of different speed events in the “Potential Target” array from the corresponding number of speed events in the “Validated Target” array. Examples for the various arrays are given below:

| | | | | | | | | | | | |
|---|---|---|---|---|---|---|---|---|---|---|---|
| Poten- | 1 | 2 | 2 | 2 | 2 | 5 | 6 | 6 | 5 | 2 | 1 |
| tial | | | | | | | | | | | |
| Targets | | | | | | | | | | | |
| Vali- | 1 | 2 | 2 | 2 | 2 | 2 | 2 | 2 | 2 | 2 | 1 |
| dated | | | | | | | | | | | |
| Targets | | | | | | | | | | | |
| Speed | 0 | 0 | 0 | 0 | 0 | 3 | 4 | 4 | 3 | 0 | 0 |
| Event | | | | | | | | | | | |
| History | | | | | | | | | | | |

At step 604 the “Speed Event History” array is searched in order to find an approaching target characteristic. In general, an approaching target characteristic will comprise a series of (contiguous) increasing numbers in the “Speed Event History” array. In the above example arrays, a series of increasing numbers is present in the “Speed Event History” and these are highlighted in bold. It will be appreciated that the number of time frames/array entries analysed, the differences between numbers in a series to qualify as an increase, etc, can be varied and selected according to experimental data and so on. If an approaching target characteristic is found then a suitable flag can be set to true.

The process then, at step 606, proceeds to search for a passing target characteristic. In general, a passing target characteristic comprises a series of (contiguous) decreasing numbers in the “Speed Event History” array. In the above example arrays, a series of decreasing numbers is present in the “Speed Event History” and these are underlined. Again, it will be appreciated that the number of time frames/array entries, differences between numbers in the series to qualify as a decrease, etc, can be varied and selected according to experimental data and so on. If a passing target characteristic is found and the approaching target characteristic flag has been set to true then this indicates that a vehicle has approached the radar device and has subsequently passed it. In this event, at step 608 a counter is incremented by one, denoting that a vehicle has passed the radar device.

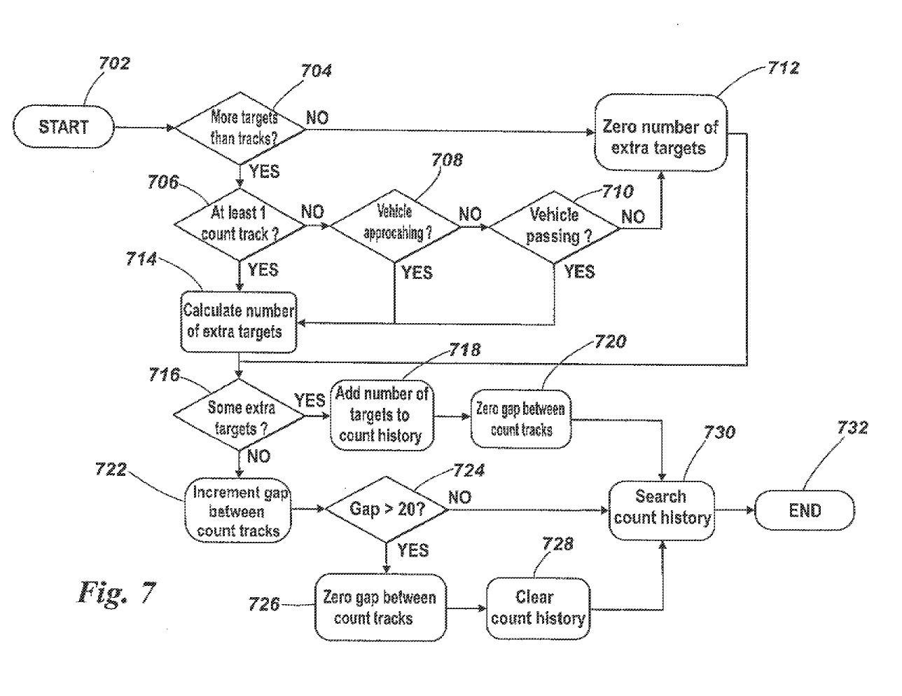

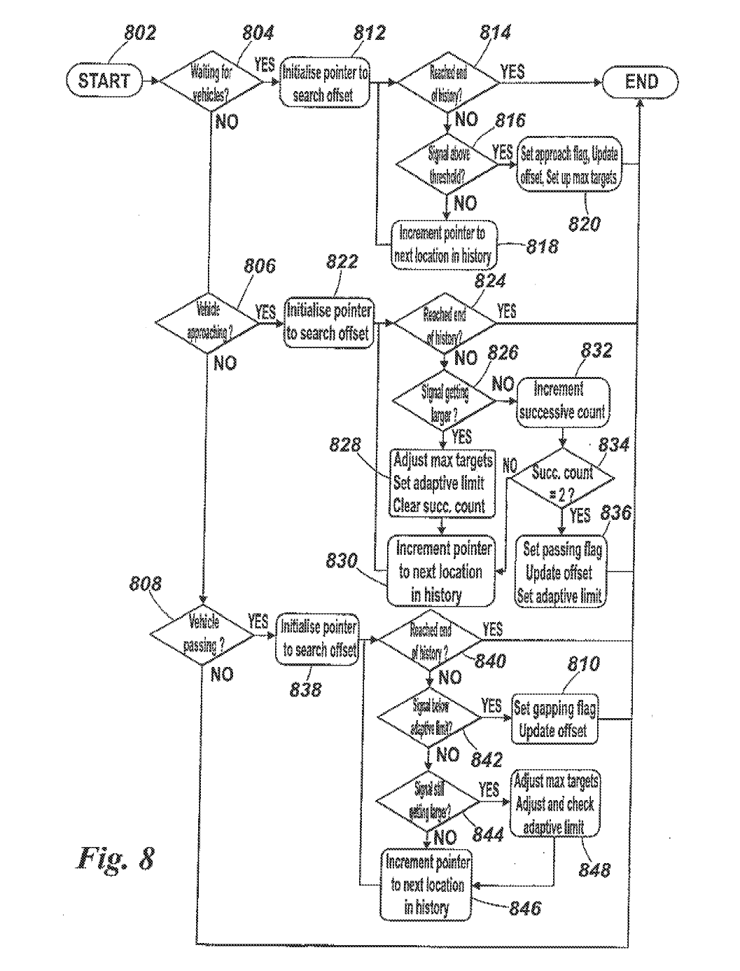

FIGS. 7 and 8 detail a particular implementation of the process that uses a state engine. The steps are performed on a radar device that is configured to obtain a measurement of the speed of a moving vehicle, as well as count the number of vehicles that have passed it. During target validation for the counting, the target validation algorithm is configured to have a longer acceptance track length than is used for speed or opto targets (i.e. a detection of vehicles above a certain speed, or simply detecting the present of vehicles). This is intended to ensure that any tracks which are caused by vehicle wheels are not counted as valid/distinct targets. As mentioned above, a difference is seen between the number of potential targets and the number of count tracks. In the embodiment this difference is stored in a variable called gNumberOfExtraTargets, and is calculated as part of the count algorithm and stored each frame in an array called the Count History. The count history is required because changes in the values of gNumberOfExtraTargets is not a smooth transition as the vehicle passes the radar; the signal can fluctuate quite significantly so a simple threshold level whereby a vehicle is counted if the number of extra targets exceeds a limit can be quite inaccurate. Instead, different vehicle states are defined for use by the count algorithm: Approaching, Passing and Gapping (i.e. a vehicle has passed the radar device and no new vehicle is being registered as approaching it). By examining the Count History, the state can be altered from Approaching through Passing to Gapping in the correct order. This has been found to be an effective method of counting.

Referring to FIG. 7, the function begins at step 702 and is intended to calculate the number of extra targets only if the system is either already tracking targets for count, or is in the middle of counting a vehicle, i.e. vehicle Approaching or Passing (steps 704, 706, 708, 710). Otherwise, the number of extra targets is set to zero (step 712). The number of extra targets, i.e. the number of potential targets compared with the number of validated targets, is calculated (step 714).

The algorithm then adds the number of extra targets to the Count History (step 718), but only if the number of extra targets is non-zero (checked at step 716). This is done in order to avoid filling up the Count History with useless information. The gap between count tracks is then set to zero (step 720).

If there are no extra targets then the gap between count tracks is incremented at step 722. If the gap then exceeds a certain number, e.g. 20, which corresponds to around 1 second without any count tracks (checked at step 724), then this indicates that there is zero count between tracks (step 726) and the Count History is cleared (step 728). Control passes from step 720/728 to step 730, where the Count History is analysed/searched and the function then terminates at step 732.

FIG. 8 illustrates an example of steps that can be performed by the Count History search function (step 730 of FIG. 7). The count function is used to add information to the Count History. Two pointers are used by the count function, gCounterHistoryNextOffset and gCounterHistorySearchOffset, which define the next position in the Count History array in which information can be stored, and the next position in the array to start looking for a vehicle to count. The array could be a circular buffer, but in another embodiment the length of the array was chosen such that around 20 seconds worth of data can be stored before the array is full, which is considered sufficient for many applications.

The function begins at step 802 and runs in one of four states: Waiting for vehicles (checked at step 804), vehicle Approaching (checked at step 806), vehicle Passing the radar device (checked at step 808), or in a Gap between vehicles (set at step 810, after processing data in the Passing state). The function analyses the Count History up to (but not including) the offset given by gCounterHistoryNextOffset, because this is the last location containing data of interest at the current time; it may be that the signal has not matured enough to contain all of the features necessary to determine that a vehicle has passed the radar, in which case no decision is made until such a time that the correct features are found.

As the vehicle state moves through the four states, the start pointer for analysis (given by gCounterHistorySearchOffset) is adjusted to ignore the feature that has just been identified. For example, having determined that a vehicle is now Approaching the radar (by finding the first location in the Count History where the number of extra targets exceeds the count in threshold), the search offset is updated to point to the next location after one which met the test criteria. This is because the next feature of interest (in the above example, looking for the next maximum value) must occur in the Count History after the feature which has just been identified, so there is no need to check ‘old’ data. Such operations are illustrated at steps 812, 814, 816 and 818 when the function is in the Waiting state.

When the vehicle state has been set to Approaching (step 820), the algorithm looks for the peak signal (the maximum number of extra targets) in order to determine that the vehicle is now Passing the radar. Example operations for this are shown at steps 822, 824, 826, 828, 830, 832, 834 and 836. Experimentation has shown that, as the signal is noisy, it is advisable to check for two successive locations after the peak signal to be sure that a peak has been found; often the signal can rise, fall and rise again over three contiguous locations in the Count History. Once the vehicle has been determined as Passing the radar, an adaptive threshold is used to switch the vehicle state into Gapping (see, e.g., steps 838, 840, 842, 810, 844, 846 and 848).

It will be understood that in some embodiments, the processes described herein are all performed by the processor onboard the device 100; however, in other embodiments, some of the steps may be performed by a remote processor based on data collected by the device 100.

I claim:

1. A method of obtaining an indication of a number of moving objects passing a speed detection apparatus, the method including:
obtaining data representing a record of speed events over a series of time frames, each said time frame in the speed events record including a record of zero or more distinct speeds detected during that time frame;
analysing the speed events data to identify approach characteristics associated with one moving object approaching the detection apparatus;
analysing the speed events data to identify passing characteristics associated with the moving object passing the detection apparatus, and
updating a moving object count after detecting a said approaching characteristic and a said passing characteristic in sequence.

2. A method according to claim 1, further including:
adding data representing a number of distinct speed event or events associated with a said time frame to a Potential Target set if the speed event or events of that time frame meets a first criteria;
adding data representing a number of distinct speed event or events associated with a said time frame to a Validated Target set if the speed event or events of that time frame meets a second criteria, and
creating a Speed Event History set, each member of the Speed Event History set comprising a result of subtracting a said Validated Target set number for a said time frame from the Potential Target set number for that time frame.

3. A method according to claim 2, wherein the step of analysing the speed events data to identify approach characteristics associated with one said moving object approaching the detection apparatus includes searching the Speed Event History set over a series of time frames for a series of numbers that correspond to approach characteristics.

4. A method according to claim 3, wherein the approach characteristics include a series of incrementing numbers.

5. A method according to claim 2, wherein the step of analysing the speed events data to identify approach characteristics associated with one said moving object passing the detection apparatus includes searching the Speed Event History set over a series of time frames for a series of numbers that correspond to passing characteristics.

6. A method according to claim 5, wherein the passing characteristics include a series of decrementing numbers.

7. A method according to claim 1, further including a step of disregarding a certain number of speed events following the incrementing of the moving object count.

8. A method according to claim 1, wherein the speed events data is generated by performing a complex FFT transformation on data based on a Doppler radar signal.

9. A method according to claim 8, wherein the Doppler radar signal comprises a continuous wave Doppler radar signal.

10. A method according to claim 1, further including performing a further function upon detection of a speed event that meets a specific criteria, such as switching on a warning signal when the speed event indicates that a certain speed threshold has been broken by the moving object.

11. A computer program product comprising a computer readable medium, having thereon computer program code means, when the program code is loaded, to make the computer execute a method of obtaining an indication of a number of moving objects passing a speed detection apparatus according to claim 1.

12. Apparatus adapted to obtaining an indication of a number of passing moving objects, the apparatus including:
a transmitter for transmitting radar signals;
a receiver for receiving radar signals;
a processing device configured to:
convert received radar signals into data representing a record of speed events over a series of time frames, each said time frame in the speed events record including a record of zero or more distinct speeds detected during that time frame;
analyse the speed events data to identify approach characteristics associated with one moving object approaching the detection apparatus;
analyse the speed events data to identify passing characteristics associated with the moving object passing the detection apparatus, and
update a moving object count after detecting a said approaching characteristic and a said passing characteristic in sequence.

13. Apparatus according to claim 12, wherein the apparatus comprises vehicle speed detection apparatus.

14. Apparatus according to claim 12, wherein the processing device implements a state engine including states of: Waiting for vehicles; Approaching vehicle detected; Passing vehicle detected, and Gapping following detection of a Passing vehicle.
